(19) United States
(12) Patent Application Publication
(10) Pub. No.: US 2026/0364587 A1
(43) Pub. Date: Nov. 19, 2026

(54) METAL BODY AND METHOD OF MANUFACTURING THE METAL BODY

(71) Applicants: Fraunhofer-Gesellschaft zur Förderung der angewandten Forschung e.V., München (DE); Alantum Europe GmbH, München (DE)

(72) Inventors: Christian Bernäcker, Dresden (DE); Tilo Büttner, Dresden (DE); Gunnar Walther, Dresden (DE); Lars Röntzsch, Dresden (DE); Thomas Rauscher, Dresden (DE); Stefan Loos, Dresden (DE); Nadine Eißmann, Dresden (DE); Andreas Tillmann, Unterhaching (DE); Sebastian Eckstein, München (DE); Sebastian Amthor, Ulm (DE); Norma Minar, München (DE)

(21) Appl. No.: 19/141,237

(22) PCT Filed: Dec. 21, 2023
(86) PCT No.: PCT/EP2023/087348

§ 371 Date: Jun. 19, 2025

(30) Foreign Application Priority Data
Dec. 22, 2022 (DE) 10 2022 214 303.5

(51) Int. Cl. B01J 37/02; B01J 25/02; B01J 37/08; C22C 19/03; C23C 4/08; C23C 4/134; C25B 11/089

(52) U.S. Cl. CPC B01J 37/0244; B01J 25/02; B01J 37/08; C22C 19/03; C23C 4/08; C23C 4/134; C25B 11/089

(57) ABSTRACT

The present invention relates to a metal body comprising a substrate (1) composed of a metallic material. At least one first layer having Ni—X—Y is deposited on a surface of the substrate, where X is a chemical element that is selected from Al, Zn, Mg, Mn, Sn and/or from a plurality of the elements mentioned, and Y is a chemical element that is selected from Mo, Cr, Fe, Cu, Co, Ti, V, Ce and/or from a plurality of the elements mentioned. The at least one first layer has at least two regions that are arranged in a lamellar manner and have different phases in terms of the ternary phase diagram. To increase the specific surface area of the at least one first layer, at least one of the lamellar phases that form a region of the at least one first layer is completely or partly leached out.

The present invention relates to a metal body and to a method of manufacturing a metal body.

To carry out an alkaline electrolysis, cost-effective and long-term efficient electrodes are required so that production costs for hydrogen are significantly reduced. Electrodes containing precious metals are usually still used for this purpose. If electrodes containing non-precious metals are used, these are generally Raney nickel electrodes or Ni—Mo electrodes. In the case of Raney electrodes, a Ni—Zn alloy or Ni—Al alloy is used that is activated by chemical leaching. For example, the patent specification DE 2 926 641 C2 discloses a method of manufacturing a Raney nickel catalyst.

However, the manufacturing processes usually offer a great deal of process variability that has a major influence on the activity of the resulting electrode. However, the manufacturing process is not suitable as the main factor for the precise manufacture of an active electrode; rather, the structure of the electrode and in particular the available electrode surface are the main factors for the resulting activity of the Raney Ni electrode.

It is therefore the underlying object of the present invention to propose a metal body and a method for its manufacture, by which the disadvantages mentioned are avoided, i.e. with which an improved electrode activity can be efficiently achieved.

This object is satisfied according to the invention by a metal body according to the main claim and a method according to the independent claim.

Advantageous embodiments and further developments are described in the dependent claims.

A metal body has a substrate composed of a metallic material, wherein at least one first layer composed of Ni—X—Y (nickel-X—Y) is deposited on a surface of the substrate, where X is a chemical element that is selected from Al (aluminum), Zn (zinc), Mg (magnesium), Mn (manganese), Sn (tin) and/or from a plurality of the elements mentioned (for example in the form of an alloy) and Y is a chemical element that is selected from Mo (molybdenum), Cr (chromium), Fe (iron), Cu (copper), Co (cobalt), Ti (titanium), V (vanadium), Ce (cerium) and/or from a plurality of the elements mentioned (for example in the form of an alloy). The at least one first layer has at least two regions that are arranged in a lamellar manner and that have different phases in terms of the ternary phase diagram. To increase the specific surface area of the at least one first layer, at least one of the lamellar phases that form a region of the at least one first layer is completely or partly leached out, i.e. is in particular acted on by a lye. In this respect, at least one chemical element X and/or Y is typically at least partly removed from the at least one first layer by applying a lye to the at least one first layer.

The leaching results in a structure that is characterized by more solid, i.e. less leached, and more porous, i.e. more leached, lamellae or intermetallic phases so that an increased specific and thus catalytically active surface area results overall. Thus, manufacturing parameters can be set in a targeted manner to provide a highly active electrode (anode and cathode) for the alkaline electrolysis and related processes. “Lamellar” should here in particular be understood as an arrangement of layers (typically disposed above one another), wherein the layers are arranged in the same way and ideally in parallel. The ternary Ni—X—Y structure used makes it possible to form various alternating ternary lamellar phases in at least one layer, of which in each case at least one lamellar phase is more leachable than others.

Provision can be made that a non-lamellar intermediate layer composed of Ni—X—Y, Ni—X, Ni—Y or X—Y is arranged between the substrate and the at least one first layer to set the properties of the metal body in a more targeted manner.

Alternatively or additionally, at least one second layer composed of Ni—X—Y can be arranged on a surface of the at least one first layer facing away from the substrate to also be able to modify the properties in a more targeted manner. In this respect, the at least one second layer can have at least two regions that are arranged in a lamellar manner and that have different phases and in this respect preferably at least one of the phases of the at least one second layer can differ from the phases of the at least one first layer, for example in the composition.

A thickness of the at least one first layer in the range 1 μm to 50 μm, preferably in the range 10 μm to 30 μm, is typically maintained, i.e. the thickness amounts to 1 μm to 50 μm, preferably in the range 10 μm to 30 μm. A thickness of the regions with different phases, i.e. of the individual lamellae, in the range 100 nm to 10 μm, preferably in the range 1 μm to 7 μm, particularly preferably in the range 3 μm to 5 μm, is maintained, i.e. the thickness of the regions with different phases amounts to 100 nm to 10 μm, preferably 1 μm to 7 μm, particularly preferably in the range 3 μm to 5 μm. Thus, a comparatively thin lamellar structure can be provided that still has a sufficiently large specific surface area.

The substrate can be formed as an open-pore foam to provide a sufficiently large surface to be coated.

An aqueous potassium hydroxide and a potassium/sodium tartrate solution can be used as a leaching solution, but NaOH, KOH, LiOH in pure form or mixtures thereof can also be used.

An electrode, in particular for alkaline electrolysis, or a catalyst can have a metal body having the above-described properties.

In a method of manufacturing a metal body, at least one first layer composed of Ni—X—Y is deposited on a surface of a substrate composed of a metallic material, where X is a chemical element that is selected from Al, Zn, Mg, Mn and Sn and/or from a plurality of the elements mentioned, and Y is a chemical element that is selected from Mo, Cr, Fe, Cu, Co, Ti, V and Ce and/or from a plurality of the elements mentioned. The at least one first layer is subjected to a heat treatment after the application, said heat treatment being aborted before a complete concentration compensation so that, in the at least one first layer, at least two regions are formed that are arranged in a lamellar manner and that have different phases in terms of the ternary phase diagram. Subsequently, to increase the specific surface area of the at least one first layer, at least one of the lamellar phases that form a region of the at least one first layer is completely or partly leached out.

Due to the formation of at least two phases, a structure is created that reacts to different degrees to an application of lye and is correspondingly altered to different degrees by the leaching. The formation of two phases is made possible in the first place by aborting the heat treatment before a complete concentration compensation.

The heat treatment typically takes place at a temperature in the range 600 °C to 850 °C, preferably 600 °C to 700 °C. This heat treatment likewise preferably takes place in a nitrogen atmosphere or a noble gas atmosphere. The heat treatment is typically carried out over a period of 1 s to 15 min, but preferably for a maximum of 60 seconds. Thus, the parameters can be set as desired to enable the formation of the two phases.

The metal body described is typically manufactured by the method described.

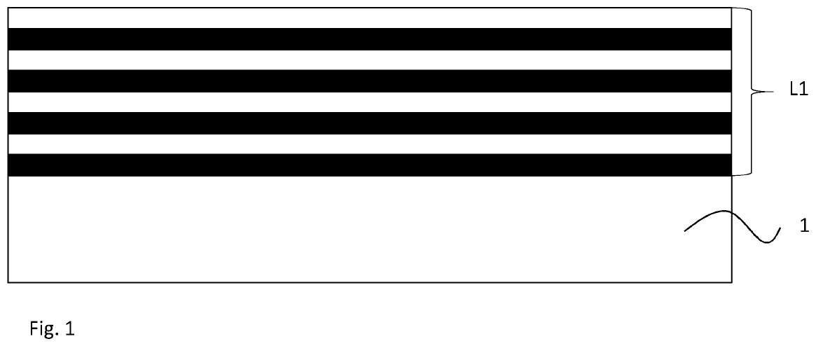

Embodiment examples of the invention are shown in the drawings and will be explained in the following with reference to FIGS. 1 to 3.

There are shown:

FIG. 1 a schematic side view of a coated metal body;

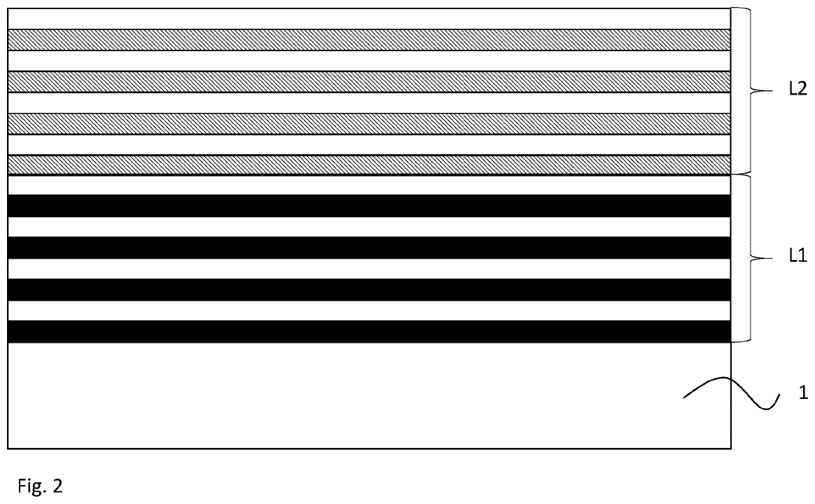

FIG. 2 a view of the metal body corresponding to FIG. 1 with two different layers; and

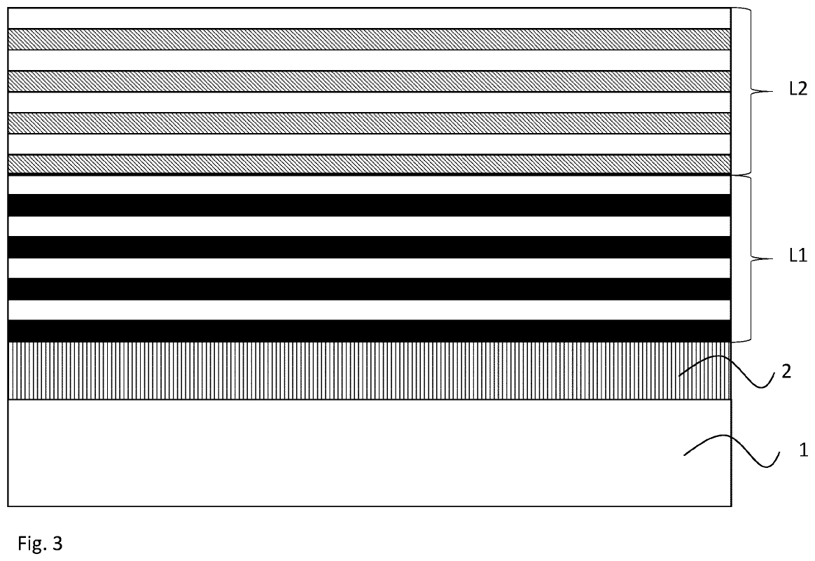

FIG. 3 a view corresponding to FIG. 1 with an intermediate layer.

FIG. 1 shows, in a schematic side view, a metal body composed of a substrate 1 and a lamellar layer L1 arranged thereon. In the embodiment example shown, the substrate 1 is an open-pore nickel foam with a pore size of between 100 μm and 5000 μm in the selected embodiment example. The lamellar layer L1 is applied at one side on the nickel foam, which can also take place at both sides in further embodiment examples. The metal body shown serves as a catalyst in heterogeneous and electrochemical catalysis. The microstructure realized by this metal body is characterized in that a Ni—Al—Y layer is applied to the substrate 1 as a metallic core, where Y is a chemical element that can be selected from Mo, Cr, Fe, Cu, Co, Ti, V and Ce or a plurality of these elements, e.g. Mo and Cr. This Ni—Al—Y layer can also surround the entire substrate 1 and is formed such that two different Ni—Al—Y phases in terms of the ternary phase diagram are always present following one another, starting from the substrate 1, in a lamellar structure shown in FIG. 1, i.e. they are alternately arranged in this layer L1. Lamellae of this lamellar structure generally extend in parallel with the surface of the substrate 1 or approximately in parallel, i.e. at an angle of at most 10°, preferably at most 5°. The thickness of individual lamellae is between 100 nm and 10 μm; the layer L1 as a whole is between 1 μm and 50 μm thick.

As shown in FIG. 2 in a schematic side view corresponding to FIG. 1, in a further embodiment example, a further laminar layer L2 can also be applied to the layer L1 or even further ones of these layers can also exist in principle. Recurring features are provided with identical reference numerals in this Figure and in the further Figure. The layer L2 also consists of (typically exactly) two different Ni—Al—X phases. In this respect, the phases of L1 and L2 can be different, wherein the further layer L2 usually has at least one phase that is different from the first layer L1. However, the layer L2 can also have exactly one phase that is different from the layer L1. The layer L2 and further such layers are each also between 1 μm and 50 μm thick. Even if aluminum is used in the embodiment examples shown, the first layer L1 or the further layer L2 can be formed from Ni—X—Y, where X is a chemical element that is selected from Al, Zn, Mg, Mn, Sn or from a plurality of these elements.

There may also be an intermediate layer 2 between the lamellar structures L1 and L2 and the substrate 1, as shown in FIG. 3 in a schematic side view corresponding to FIGS. 1 and 2. This intermediate layer 2 is preferably formed from Ni₂₋ₓXₓAl₃ and is likewise between 1 μm and 50 μm thick.

After the application of the layers L1, L1 and L2 or the intermediate layer 2 and L1, L1 and L2, a leaching step for a selective leaching of aluminum (or, if no aluminum is used, of the corresponding substitute) takes place, which leads to a preferred dissolution of one of the two lamella-forming phases within the respective layer L1 or L2. A lamellar structure is thereby formed that is characterized by firmer, i.e. less leached, and more porous, i.e. more leached, lamellae or phases. Thus, an increased specific surface area results overall, i.e. the catalytically active surface becomes larger.

The manufacturing process of the metal body can thus be described as follows in a first example: Ni—Mo powder is applied to a Ni foam and, in a first heat treatment step, is then alloyed-in. A Ni—Mo foam is thus produced. This Ni—Mo foam is then coated at one side with aluminum by atmospheric plasma spraying and is subjected to a second heat treatment step. However, the second heat treatment step is completed before a complete concentration compensation can take place so that lamellar phase regions are formed from the components Ni, Mo and Al. This foam is now called Raney-Ni—Mo foam.

Finally, the aluminum content in the Raney-Ni—Mo foam is leached out in an alkaline solution. This leaching out takes place in an aqueous solution of potassium hydroxide (1.8 M) and potassium/sodium tartrate (1.5 M) at ambient conditions. The leaching-out step takes 24 hours in the embodiment example shown, but can also take between 18 hours and 30 hours.

Subsequently, the leaching solution is then replaced and heated to 353 K until the gas development stops, which usually takes 2 hours to 4 hours. A respective one of the two phases can be leached out better than the other one and a structure with a very large inner surface area is thus produced from the more durable lamellae. The metal bodies produced in this way are removed from the leaching solution and thoroughly washed with water. This last-mentioned leaching step is always the same for the variants discussed below, apart from adjustments to the temperature (which is, however, always in the range 330 K to 370 K) or an adjustment to the composition of the leaching solution.

In a first variant of the first example described, a Ni—Mo powder of the composition Ni_{71.2}MO_{28.9} is taken and the first heat treatment takes place at 1280 °C and lasts one hour. Due to the atmospheric plasma spraying, the aluminum coating then takes place and the second heat treatment takes place at 670 °C in a nitrogen atmosphere. Typically, this heat treatment, the second one in the present embodiment example, takes place at a temperature that is at least 10 K and at most 20 K above the melting temperature of the element that was applied as a coating.

In a second variant, a Ni—Mo powder of the composition Ni_{71.2}MO_{28.9} is again taken and is subjected to the first heat treatment for one hour. As with the first variant, the aluminum coating likewise takes place by atmospheric plasma spraying and the second heat treatment takes place at 670 °C, but now in an argon atmosphere.

In a third variant, the second heat treatment can also take place at a reduced temperature of 660 °C, while the further parameters correspond to the second variant.

In a fourth variant of the first example, a Ni—Mo powder of the composition Ni_{71.2}MO_{28.9} is again taken and is subjected to the first heat treatment at 1280 °C for one hour. The sample to be treated is then sprinkled with aluminum powder at one side until a weight ratio of aluminum powder to foam (mass of the aluminum powder m_{Al powder}/(mass of the mesh mₘₑₛₕ+mass of the aluminum powder m_{Al powder})) of 13.9 percent is reached. As with the second variant, the final heat treatment takes place at 670 °C in an argon atmosphere.

In a second example, a Ni—Mo—Y mesh (for example, a Hastelloy C276 mesh) is coated with aluminum and is subjected to the first heat treatment so that the lamellar phase regions are formed from the components Ni, Mo and Al and is now referred to as a Raney Ni—Mo mesh. The aluminum content is in turn leached out by the aforementioned leaching solution over 24 hours. Then, as in the first example, the leaching solution is replaced with a fresh potassium hydroxide (1.8 M) solution and a potassium/sodium tartrate (1.5 M) solution and is heated to 353 K until the gas development stops after 2 hours to 4 hours. The metal body is thoroughly washed with water as usual. The leaching step is also identical for all the variants of the second example that are mentioned below.

In a first variant of the second example, the mesh as the substrate 1 is sprinkled with aluminum powder until an aluminum powder-to-mesh weight ratio of ((mass of the aluminum powder m_{Al powder}/(mass of the mesh mₘₑₛₕ+mass of the aluminum powder m_{Al powder}))) of 13.4 percent is reached. The heat treatment (corresponding to the second heat treatment of the first example) subsequently takes place at 680 °C in a nitrogen atmosphere.

In a second variant of the second example, the mesh is sprinkled with the aluminum powder until the weight proportion of 33 percent is reached and the described heat treatment is carried out in a nitrogen atmosphere again.

In a third variant of the second example, a 0.1 mm thick aluminum foil is pressed at one side onto the Ni—Mo—X mesh at 70 MPa and the aforementioned heat treatment is carried out again.

In a fourth variant of the second example, the aluminum foil is pressed at one side onto the mesh at 145 MPa and the heat treatment described is then carried out.

The method is flexibly settable: Thus, it may, for example, be that the more leachable phase of the layer L1 also occurs in the lamella packet L2, but that the less leachable phase is there. Depending on the temperature control and time control, layer structures with specific properties can thus be generated in a targeted manner. The metal body is used as an electrode in electrolysis (for example, alkaline electrolysis or chlor-alkali electrolysis) or other electrochemical processes, such as electro-organic synthesis or electrochemical CO₂ reduction, and is used as a Raney-Ni catalyst in heterogeneous catalysis.

Only the features of the various embodiments that are disclosed in the embodiment examples can be combined with one another and can also be claimed individually.

1-12. (canceled)

13. A metal body comprising a substrate composed of a metallic material,
wherein
at least one first layer composed of Ni—X—Y is deposited on a surface of the substrate, where
X is a chemical element that is selected from Al, Zn, Mg, Mn, Sn and/or from a plurality of the elements mentioned, and
Y is a chemical element that is selected from Mo, Cr, Fe, Cu, Co, Ti, V, Ce and/or from a plurality of the elements mentioned, and
wherein the at least one first layer has at least two regions that are arranged in a lamellar manner and that have different phases in terms of the ternary phase diagram, wherein,
to increase the specific surface area of the at least one first layer, at least one of the lamellar phases that form a region of the at least one first layer is completely or partly leached out.

14. The metal body according to claim 13, wherein a non-lamellar intermediate layer composed of Ni—X—Y, Ni—X, Ni—Y or X—Y is arranged between the substrate and the at least one first layer.

15. The metal body according to claim 13, wherein at least one second layer composed of Ni—X—Y is arranged on a surface of the at least one first layer facing away from the substrate, wherein the at least one second layer has at least two regions that are arranged in a lamellar manner and that have different phases.

16. The metal body according to claim 13, wherein a thickness of the at least one first layer in the range 1 μm to 50 μm.

17. The metal body according to claim 13, wherein a thickness of the regions having different phases, i.e. of the individual lamellae, in the range 100 nm to 10 μm, is maintained.

18. The metal body according to claim 13, characterized in that the substrate is formed as an open-pore foam.

19. The metal body according to claim 13, wherein the lamellar layer is formed at both sides on the substrate.

20. The metal body according to claim 13, wherein the lamellae in the lamellar layer are formed at an angle of at most 10° to the surface of the substrate.

21. An electrode or a catalyst comprising a metal body, the metal body comprising a substrate composed of a metallic material, wherein at least one first layer composed of Ni—X—Y is deposited on a surface of the substrate, where X is a chemical element that is selected from Al, Zn, Mg, Mn, Sn and/or from a plurality of the elements mentioned, and Y is a chemical element that is selected from Mo, Cr, Fe, Cu, Co, Ti, V, Ce and/or from a plurality of the elements mentioned, and wherein the at least one first layer has at least two regions that are arranged in a lamellar manner and that have different phases in terms of the ternary phase diagram, wherein, to increase the specific surface area of the at least one first layer, at least one of the lamellar phases that form a region of the at least one first layer is completely or partly leached out.

22. A method of manufacturing a metal body, in which
at least one first layer composed of Ni—X—Y is deposited on a surface of a substrate composed of a metallic material, where
X is a chemical element that is selected from Al, Zn, Mg, Mn and Sn and/or from a plurality of the elements mentioned, and
Y is a chemical element that is selected from Mo, Cr, Fe, Cu, Co, Ti, V and Ce and/or from a plurality of the elements mentioned, and
the at least one first layer is subjected to a heat treatment after the application, said heat treatment being aborted before a complete concentration compensation so that, in the at least one first layer, at least two regions are formed that are arranged in a lamellar manner and that have different phases in terms of the ternary phase diagram, and wherein,
subsequently, to increase the specific surface area of the at least one first layer, at least one of the lamellar phases that form a region of the at least one first layer is completely or partly leached out.

23. The method according to claim 22, wherein the heat treatment is carried out at a temperature in the range 600 °C to 850 °C and likewise preferably in a nitrogen atmosphere or a noble gas atmosphere.

24. The method according to claim 22, wherein the heat treatment is carried out over a period of 1 s to 15 min.

25. The metal body according to claim 15, wherein at least one of the phases of the at least one second layer differs from the phases of the at least one first layer.

26. The method according to claim 23, wherein the heat treatment is carried out in a nitrogen atmosphere or a noble gas atmosphere.

27. The method according to claim 24, wherein the heat treatment is carried out for a maximum of 60 s.
